(19) United States
(12) Patent Application Publication
(10) Pub. No.: US 2025/0185529 A1
(43) Pub. Date: Jun. 12, 2025

(54) Agricultural Working Machine with a Platform for Walking on the Working Machine

(71) Applicant: Amazonen-Werke H. Dreyer SE & Co. KG, Hasbergen (DE)

(72) Inventors: Daniel MERTENS, Oldenburg (DE); Thomas ERDMANN, Hude (DE)

(73) Assignee: Amazonen-Werke H. Dreyer SE & Co. KG, Hasbergen (DE)

(21) Appl. No.: 18/844,876

(22) PCT Filed: Feb. 27, 2023
(86) PCT No.: PCT/EP2023/054769

§ 371 Date: Sep. 6, 2024

(30) Foreign Application Priority Data
Mar. 8, 2022 (DE) 10 2022 105 323.7

(51) Int. Cl. A01B 75/00; A01B 73/06

(52) U.S. Cl. CPC A01B 75/00; A01B 73/065

(57) ABSTRACT

An agricultural working machine, in particular distribution machine, having a platform which is provided for walking on the working machine and preferably has at least one step and/or a tread, and is arranged on the working machine so as to be able to be brought into different positions and comprises at least one railing, in particular designed in the manner of a guardrail. In order to design a working machine in such a way that the platform, in particular the railing, is able to be brought particularly compactly to the working machine in the transport position, it is provided that the railing is divided at least in sections into a plurality of sections, preferably aligned at least approximately in parallel, which are pivotable, in particular foldable, in mutually repellent and/or opposite directions for lowering the railing.

### CROSS REFERENCE TO RELATED APPLICATIONS

The present application claims priority under 35 U.S.C. § 365 to PCT/EP2023/054769 filed on Feb. 27, 2023 and under 35 U.S.C. § 119 (a) to German Application No. 10 2022 105 323.7 filed on Mar. 8, 2022.

### BACKGROUND

The disclosure relates to an agricultural working machine with a platform for walking on the working machine according to the preamble of claim 1.

In the field of agriculture, a large number of variants of towed, mounted and/or self-propelled working machines are known. These include distribution machines, which are intended for spreading distribution materials. Depending on the type of application, such distribution machines can, for example, be designed in the manner of agricultural seed and/or fertilizer machines and intended for spreading granular and/or particle-like distribution materials, such as seeds and/or fertilizer. In other applications, such distribution machines may also be designed in the manner of agricultural field sprayers and intended for the application of liquid distribution materials, such as plant protection agents, pesticides and/or weed killers or the like. Furthermore, in some applications, agricultural tillage combinations are also used, which are composed of several different agricultural working machines, such as distribution machines and/or soil tillage machines, for example in the manner of large-area working machines and/or direct seeding machines.

Due to the relatively large dimensions or sizes of such working machines, a platform is often required in practice, which is suitable and/or intended for an operator to walk on the working machine. A platform of this kind is generally used by the operator to access a storage container assigned to the working machine, which is intended for storing the materials to be applied. For example, to open and/or close a covering means, in particular a cover or a tarpaulin, of the storage container or for various inspection and/or maintenance purposes.

Such agricultural working machines with a platform are known, for example, from the publications U.S. Pat. No. 5,357,884 A and/or US 2019/0143902 A1.

Since such platforms are only used by the operator when required or in certain situations, working machines have become known in the prior art which allow such platforms to be at least partially placed in different positions and thus stowed in a space-saving manner, for example during spreading operations and/or a transport position of the working machine.

Such working machines are described, for example, in the publications EP 0 979 759 A1 and/or WO 2022/010405 A1. Accordingly, a platform is known which is able to be brought into different positions, which has at least one railing, in particular designed in the manner of a guardrail, and which is arranged on the working machine. In particular, such platforms have at least one step and/or at least one tread, via which the platform is easily accessable by an operator.

### SUMMARY

With such known working machines, however, the stowage of the railing has still proven to be inadequate, as these have so far been relatively bulky to place on the working machine, especially for the transport position. In particular, the free space required during the transport position for placing and/or stowing working tools of the working machine is therefore particularly restricted or limited.

The object of the disclosure is thus to design a working machine in such a way that the platform, in particular the railing, is able to be brought particularly compactly to the working machine in the transport position.

This object is solved in accordance with the disclosure in that the railing is divided at least in sections into several, preferably at least approximately parallel, aligned sections which can be pivoted, in particular folded, in mutually repellent and/or opposite directions to lower the railing.

Preferably, parallel and/or longitudinally aligned segments of the railing are provided, which are divided into vertical and/or longitudinally successively arranged sections. The railing is designed in such a way that the sections are preferably placed at least approximately next to each other in an upright position. In other words, in an upright or raised position, the sections preferably form a railing assembled in sections, which is particularly preferably assigned to a longitudinal side of the platform. Furthermore, the railing is preferably designed, at least in sections, in such a way that the individual sections are each pivotable and/or foldable separately from one another for lowering from the raised position.

The railing preferably comprises a plurality of at least substantially vertically aligned post elements, of which one or more, particularly preferably at least two, are assigned to each section. A railing infill is provided between the several, in particular two, post elements of at least one individual section, which is preferably designed from one or more, in particular horizontally aligned, rod and/or tube elements. It is preferably provided that the rod and/or tube elements are movably, in particular rotatably, connected to the post elements. Furthermore, the railing, in particular each section, has at least one handrail for the operator arranged on an upper side, wherein alternatively or additionally at least one upper rod and/or tube element can also be designed as a handrail.

Furthermore, the platform is preferably arranged on a frame and/or at least one storage container assigned to the working machine. Furthermore, the platform is preferably arranged laterally from and/or to the storage container, so that an opening designed on the storage container is accessible to an operator via the platform.

In a preferred embodiment of the working machine according to the disclosure, the sections are each pivotable about separate pivot axes assigned to the respective sections. Each of the sections can be pivotable about at least one or more, preferably two, pivot axes aligned at least approximately parallel to each other. Preferably, swivel and/or pivot bearings arranged on the platform are provided for this purpose, to which at least one, preferably each, of the post elements is connected. The pivot axes are particularly preferably aligned at least approximately perpendicular and/or transverse to a longitudinal axis of the railing, in particular the sections, so that the post elements and thus the sections are pivotable and/or foldable in a direction pointing in the longitudinal direction of the platform.

In a further development of the working machine according to the disclosure, the sections are each able to be brought separately from one another in a folded and/or folded-in manner when the railing is lowered. The sections, which form at least one segment of the railing, can thus be stowed in individual packages and/or bundles separated from one another along the longitudinal side of the platform, in particular of the railing. It is particularly preferred that only the post elements and/or the rod or tube elements of a single section are placed against each other in the folded non-operating position.

In another preferred embodiment of the working machine according to the disclosure, the sections for raising the railing are pivotable towards each other. While the sections for lowering the railing are swiveled and/or folded away from each other, the sections for raising the railing are swiveled and/or folded towards and/or on each other again. When raising the railing, in particular the sections, the post elements and/or the rod or tube elements previously placed against each other are released and/or moved away from each other again, so that they are spaced apart from each other in the raised operating position.

In another further development of the working machine according to the disclosure, the platform has at least one tread which is adjustable, at least in sections, into a raised position when the railing is lowered and/or during lowering of the railing. In a further particularly preferred embodiment of the working machine according to the disclosure, the tread is divided into a plurality of segments, wherein at least one of the segments is adjustable into the raised position. Preferably, the tread forms the bottom of the platform, which can be stepped on or walked on by the operator. The at least one or more raisable segments of the tread are preferably pivotable and/or foldable about an axis approximately perpendicular to the pivot axis of the sections and/or an axis aligned at least approximately parallel to the longitudinal axis of the railing. This embodiment has the advantage that an additional free space for stowing and/or placing working tools of the working machine is thus created in a particularly simple manner by the tread, which in turn results in a particularly compact working machine in the transport position.

In a further development of the working machine according to the disclosure, the sections are placeable at a defined distance from each other when the railing is lowered. In other words, the individual sections, which are folded together separately from one another, are each placed in different regions on the platform in the lowered state, so that a defined distance and thus a defined free space results between the sections and/or regions in which the sections are placed. The distance and/or free space is designed in such a way that it corresponds at least approximately to the length of the at least one raisable and/or pivotable segment of the tread. In particular, it is provided that the at least one segment of the tread can be guided past the sections of the railing during raising and/or pivoting.

Furthermore, a working machine according to the disclosure is preferred in which at least one actuating element is provided between the railing and the tread, in particular between at least one section and at least one segment. The actuating element is preferably designed in the manner of an actuating lever and/or a rod and is particularly preferably designed to transmit an actuating force between the railing and the tread, in particular between the at least one section and the at least one segment. The railing and the tread are thus connected and/or connectable to each other in a force-transmitting manner via the actuating element. The actuating element is also preferably designed to raise the tread, in particular the at least one segment, during lowering of the railing. For this purpose, preferably at least one of the sections is coupled to the actuating element in a rotationally fixed manner.

In another preferred embodiment of the working machine according to the disclosure, the platform is assigned at least one actuator which is designed to adjust the sections, and in particular the tread or the at least one segment, together, preferably in an alternating and/or successive manner. In a particularly preferred embodiment, it is provided that the at least one actuator is designed to pivot the individual sections and/or the at least one segment of the tread alternately and/or successively. Alternatively or additionally, the actuator may also be designed to pivot and/or adjust the sections of the railing and/or the at least one segment of the tread together and/or simultaneously. In particular, a mechanism and/or a transmission device is provided for this purpose, via which the at least one actuator is coupled, preferably in an actuating force-transmitting manner, to the sections of the railing and/or the tread. Alternatively or additionally, further actuators would also be conceivable, which are coupled and/or connected together or individually to at least one of the sections and/or the segment. The at least one actuator is particularly preferably designed in the manner of a hydraulically, pneumatically and/or electrically operable actuating cylinder. Further preferred is a motion converter arranged between the actuator and the sections, which is designed to convert linear motions of the actuator into rotary motions for swiveling the sections and/or the tread.

In an alternative, but equally preferred embodiment of the working machine according to the disclosure, the at least one actuator can also be designed as a rotary drive.

In a particularly preferred embodiment of the working machine according to the disclosure, at least one sensor device is assigned to the platform, which is designed to detect at least one position of the platform, in particular of the sections and/or of the tread. The at least one sensor device is preferably arranged on the at least one actuator.

In a particularly preferred development of the working machine according to the disclosure, the positions of the platform, in particular of the sections and/or of the tread, are adjustable in a manner which is remotely operated and/or selectable by an operator. In particular, it is provided that the positions of the platform are adjustable by the operator by means of the actuator and by means of an operating switch, lever or the like arranged on the working machine or alternatively and/or additionally via an operating and/or display means arranged, in particular, in a driver's cab. Alternatively or additionally, it is conceivable that the positions of the platform, in particular of the railing, are adjustable automatically depending on the intended operating positions of the working machine, for example for an operating position or a transport position of the working machine. In other words, it may alternatively or additionally be provided that the platform is designed to change position as soon as and/or before the machine is moved from the operating position to the transport position and/or after the working machine is moved from the transport position to the operating position. Furthermore, it can be provided, for example, that the operator actuates the change of position of the platform, in particular of the railing, as soon as a filling operation of the storage container is intended.

In another particularly preferred embodiment of the working machine according to the disclosure, the positions of the platform, in particular the sections and/or the tread, are adjustable automatically, in particular by means of a control and/or feedback control system assigned to the working machine. In particular, the positions are adjustable in such a way that the platform, preferably the sections and/or the tread, are folded in and/or out automatically by means of the actuator and/or the control and/or feedback control system.

In another particularly preferred further development of the working machine according to the disclosure, the positions of the platform, in particular the sections and/or the tread, are automatically adjustable depending on a position and/or change in position of the working machine, preferably of working tools, frames and/or at least one foldable cross member assigned to the working machine, which can be detected in particular by sensors. In particular, it is provided here that the position of the platform is adjusted after detecting a change in position of the working machine, preferably of working tools, frames and/or at least one foldable cross member assigned to the working machine. In particular, an angle of the working tools, the frame and/or at least one foldable cross member is detectable by means of an assigned further sensor device. This is advantageous, for example, for avoiding collisions between the platform and other parts of the working machine, in particular foldable parts.

In another particularly preferred embodiment of the working machine according to the disclosure, the platform is arranged via several pivot points on a frame of the working machine and/or on at least one storage container assigned to the working machine. At least one of the pivot points is assigned adjustment means which are designed to align the sections, preferably an alignment of the sections, with each other. The adjustment means are preferably designed to align the sections, in particular the rod and/or tube elements of the different sections or the handrail, which are placeable against each other in the raised position. This is particularly advantageous in the event of distortion, such as a distortion caused by welding during the manufacturing of the railing.

In a further particularly preferred development of the working machine according to the disclosure, the working machine is designed in the manner of a towed agricultural seed drill.

### BRIEF DESCRIPTION OF THE DRAWINGS

Further details of the disclosure can be found in the example description and the drawings.

The drawings show

FIG. 1 an agricultural working machine with a platform according to the disclosure in operating position and in perspective view from the front;

FIG. 2A the platform according to the disclosure in the upright position and in a detailed perspective view;

FIG. 2B the platform from FIG. 2A during lowering of a section of a railing according to the disclosure;

FIG. 2C the platform of FIG. 2A in lowered non-operating position; and

FIG. 3 the agricultural working machine from FIG. 1 in transport position.

### DETAILED DESCRIPTION

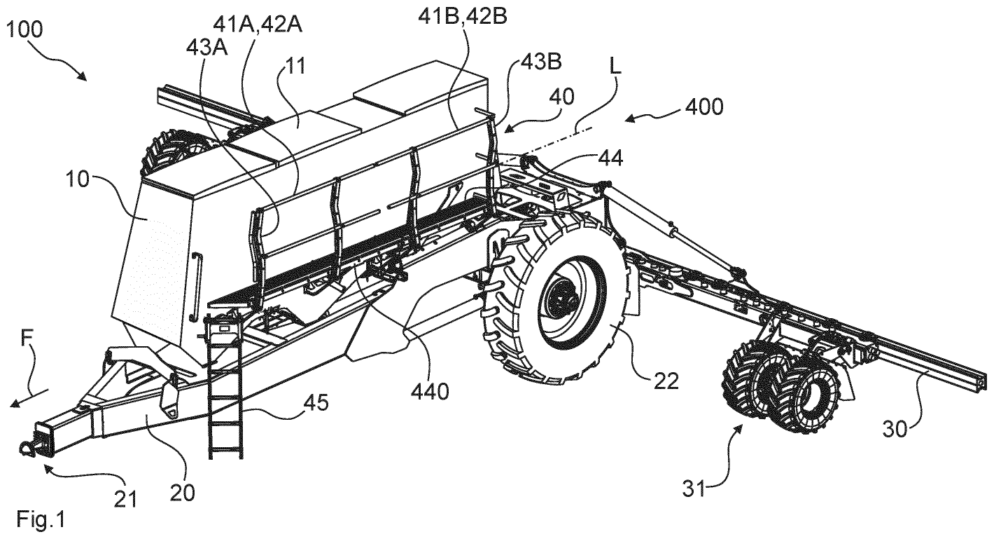

A platform 400 of an agricultural working machine 100, here for example of a seed drill, for walking on, is arranged on a storage container 10 assigned to the working machine 100 and can be seen in FIG. 1. The storage container 10 is intended for holding distribution material to be spread, here granular distribution material or seed and/or fertilizer, and is arranged on a frame 20 of the working machine 100. A drawbar 21 is located at the front of the frame 20, which is to be arranged on a coupling device of an agricultural tractor not shown here. On a rear side of the frame 20, in addition to a impeller 22, a sowing rail 30 or a cross member is coupled in an indicated manner, to which working tools 31, such as sowing coulter, packer and/or support wheels or the like, are typically arranged and/or attached. In this view, the sowing rail 30 or the cross member, which are adjustable between different positions, in particular between an operating position and a transport position, is shown in an unfolded operating position pointing at least approximately transversely to the direction of travel F.

At this point, it should again be explicitly mentioned that, in an alternative embodiment, the towed working machine 100 shown can also be carried by a tractor or be designed to be mounted and/or built on the latter. Furthermore, a self-propelled working machine 100 would also be conceivable as an alternative. Depending on the type of application and/or design of the working machine 100, the storage container 10 may alternatively or additionally also be provided for holding liquid distribution material, such as spraying agent or the like. In particular, the working machine 100 can also be designed as an agricultural field sprayer.

In addition to a step 45 designed as a ladder, the platform 400 arranged at the side of the storage container 10 also has a tread 44 forming the bottom of the platform 400, via which an operator can step onto and/or enter the platform 400. The platform 400 provides easy access to regions that are otherwise difficult or impossible for the operator to reach from the bottom, such as the top of the storage container 10. In particular, the platform 400 can be used by the operator to open and/or close cover means arranged on the top of the storage container 10, which in this embodiment example are designed in the manner of lockable and/or pivotable container lids 11. This is particularly helpful, for example, for filling processes of the working machine 100, in particular of the storage container 10. It should be explicitly mentioned here that the platform 400 may alternatively or additionally also be provided and/or usable for maintenance, conversion, operation and/or adjustment purposes of the working machine 100. Furthermore, in another application example not shown, the platform 400 may alternatively or additionally also be provided for accessing a driver's cab arranged on the working machine 100.

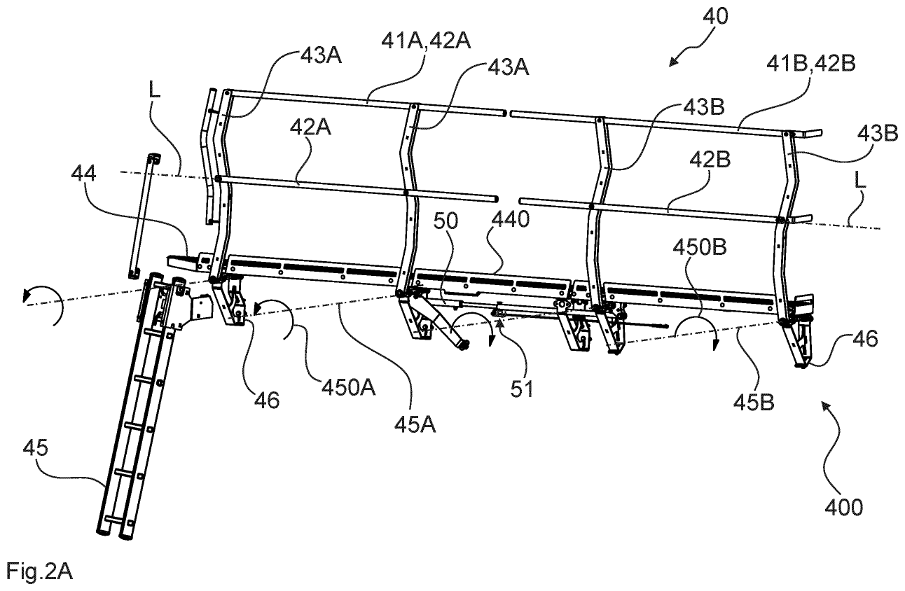

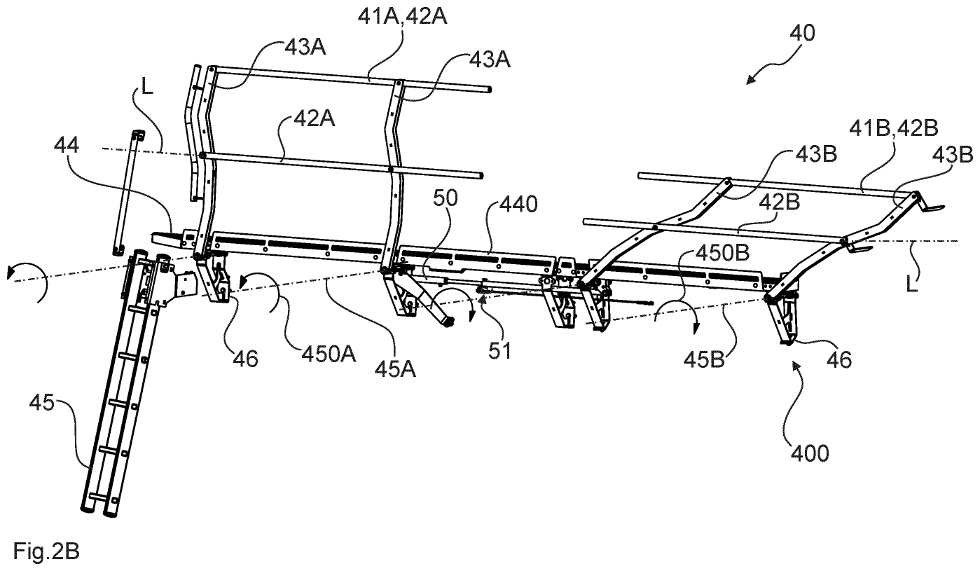

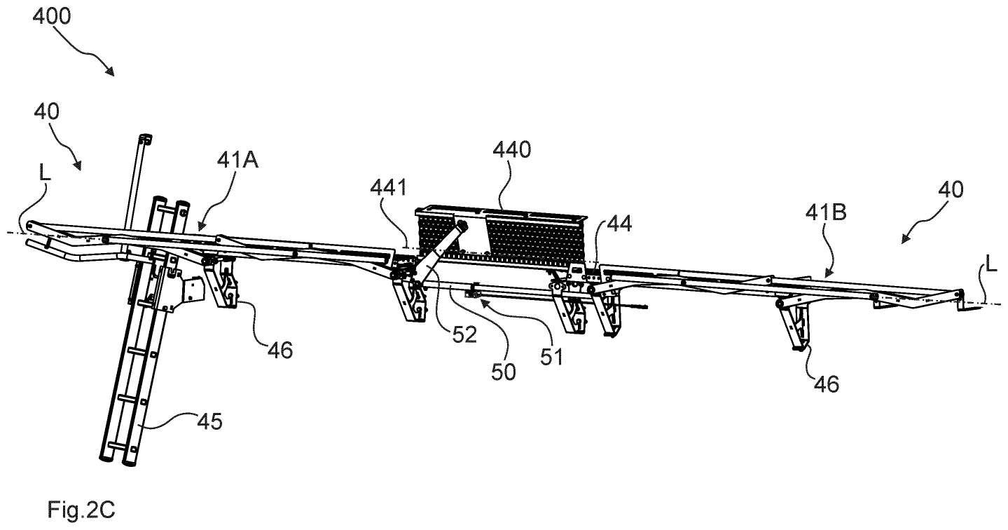

As can be seen particularly well in FIG. 2A, the platform 400 comprises a railing 40, which is designed in the manner of a guardrail and along a longitudinal side or corresponding to a longitudinal axis L of the platform 400. Furthermore, the railing 40 has a plurality of rod and/or tube elements 42A, 42B, which are aligned in particular horizontally and designed at least in part in the manner of a handrail and which are each arranged on and/or between a plurality of post elements 43A, 43B of the platform 400.

The platform 400 shown is designed to be able to be brought into different positions for space-saving stowage when not in use, such as for a transport position of the working machine 100 and/or for distribution or spreading operations. In order to stow the platform 400 in a simple and/or particularly space-saving manner, the railing 40 according to the disclosure is divided at least in sections into a plurality of sections 41A, 41B, in particular sections which are aligned at least approximately parallel and which are be pivotable, in particular foldable, in mutually repellent and/or opposite directions for lowering the railing 40. In FIGS. 1 and 2A, the railing 40 is shown in a fully upright position intended for stepping on, in which the sections 41A, 41B are placed along the longitudinal side or parallel to the longitudinal axis L at least approximately adjacent to and/or behind one another, and in particular in which the post elements 43A, 43B are aligned at least substantially in an upwardly vertical direction.

The sections 41A, 41B are each pivotable about separate pivot axes 45A, 45B, which are preferably aligned at least approximately parallel to each other and at least approximately perpendicular and/or transverse to the longitudinal axis L of the railing 40, in particular of the sections 41A, 41B. Each of the post elements 43A, 43B is arranged for this purpose, in particular at one of its ends, within the platform 400 via a respective assigned pivot bearing not shown in the figures. Starting from the upright position shown here, the post elements 43A, 43B and thus the sections 41A, 41B are each pivotable about the pivot axes 45A, 45B in the indicated pivot directions 450A, 450B for lowering the railing 40. For raising the railing 40, the sections 41A, 41B are also pivotable in a pivot direction 450A, 450B opposite to that shown.

In FIG. 2B, the platform 400 is shown during adjusting or pivoting of the railing 40, in particular the sections 41A, 41B. As can be seen, only one of the sections 41A, 41B, in this case the right-hand or second section 41B, is initially pivoted along the longitudinal side or parallel to the longitudinal axis L for this purpose. Alternatively or additionally, it may also be provided that in another embodiment, starting from the center of the platform 400, initially only one side with several sections 41A, 41B is adjusted and/or pivoted. Furthermore, alternatively or additionally, it would also be conceivable that all sections 41A, 41B are simultaneously adjusted and/or pivoted. In the embodiment example shown, it is provided in particular that the at least one other or the left-hand section 41A is only pivoted as soon as the right-hand or second section 41B is completely folded down.

As can also be seen, the rod and/or tube elements 42A, 42B are arranged to be rotatable relative to the post elements 43A, 43B. Thus, the rod and/or tube elements 42A, 42B can be rotated relative to the post elements 43A, 43B during the lowering of the railing 40.

FIG. 2C shows the platform 400 with the railing 40 fully lowered or folded down. Here, the sections 41A, 41B are each able to be brought separately from each other in a folded and/or folded-in manner. In particular, it can be seen here that one of the plurality of sections 41A, 41B, here the left section 41A, is placed facing a first or left end of the platform 400, while the at least one other of the plurality of sections 41A, 41B, here the right section 41B, is placed facing a second or right end of the platform 400.

As also shown, it is further provided that the tread 44 is adjustable, at least in sections, into a raised position when the railing 40 or the sections 41A, 41B are lowered and/or during lowering. The tread 44 has a raisable segment 440 for this purpose. In an alternative embodiment, it would be conceivable that the tread 44 has several raisable segments 440 or that the entire tread 44 is designed to be raisable.

To adjust and/or raise the at least one segment 440 of the tread 44, an actuating element 52, here designed in the manner of a lever, is provided between the railing 40 and the tread 44. The actuating element 52 is arranged here in a actuating force-transmitting manner between at least one section 41A, 41B, here the left-hand or first section 41A, and the raisable segment 440 and is designed to raise the segment 440 during and/or after lowering of the railing 40. In particular, it is provided for this purpose that the actuating element 52 is connected to the railing 40, in particular to one of the sections 41A, 41B, in a rotationally fixed manner and/or is arranged in such a way that the actuating element presses from below against the at least one segment 440 when the railing 40 is at least partially lowered and thus pivots the segment 440 about an axis 441 aligned at least approximately parallel to the longitudinal axis L.

The railing 40 is further designed in such a way that the sections 41A, 41B are placeable at a defined distance from each other when the railing 40 is lowered. The distance between the folded-down sections 41A, 41B corresponds at least approximately to the length of the raisable segment 440 of the tread 44, so that the segment 440 can be guided past the sections 41A, 41B during and/or for raising.

For adjusting the platform 400, an actuator 50 is also assigned to the railing 40, which is designed in the manner of an actuating cylinder and is adapted to adjust the sections 41A, 41B, and in particular the tread 44 or the at least one segment 440. For this purpose, the actuator 50 is designed to be remotely operated by the operator and able to be operated by means of hydraulics and/or pneumatics. Alternatively or additionally, the actuator 50 is also able to be operated and/or actuated electrically. Furthermore, the actuator 50 may also comprise a rotary drive as an alternative or in addition to the embodiment shown.

Furthermore, several actuators 50 would also be conceivable, which are assigned separately to different sections 41A, 41B and/or the tread 44, for example. In addition, the one or more actuators 50 may be assigned a motion converter, not shown in the figures, which is designed to convert linear motion of one or more actuators 50 into rotary and/or pivoting motion.

In particular, it is provided that the one or more actuators 50 are designed to adjust and/or pivot the sections 41A, 41B, and in particular the at least one segment 440, in an alternating and/or sequential manner or alternatively together. The one or more actuators 50 may further be able to be actuated in a selectable manner automatically by a control and/or feedback control system assigned to the working machine 100 and/or manually by the operator, so that the railing 40 can be raised and/or folded down as required.

For monitoring and/or detecting a current position of the platform 400, in particular of the railing 40, a sensor device 51 is assigned to the platform 400 in the embodiment example shown, which is arranged here on the actuator 50 and is designed to detect at least the position of the platform 400, in particular of the sections 41A, 41B. It should be explicitly mentioned again here that the sensor device 51 can alternatively or additionally also be arranged on at least one of the sections 41A, 41B and/or on the tread 44. Thus, the control and/or feedback control system and/or the operator can easily monitor the position of the platform 400 and adjust the position in a selectable manner if necessary. Alternatively or additionally, the working machine 100, in particular the working tools 31, the frame 20 and/or the sowing rail 30 or the cross member, can be assigned at least one further sensor device which is designed to detect its position and/or a change in position, for example an angling. In particular, it may be provided that the positions of the platform 400 are adjustable automatically, preferably by means of the actuator 50 and/or the feedback control system, depending on the positions of the working machine 100, in particular the working tools 31, the frame 20 and/or the sowing rail 30, detected by the further sensor device.

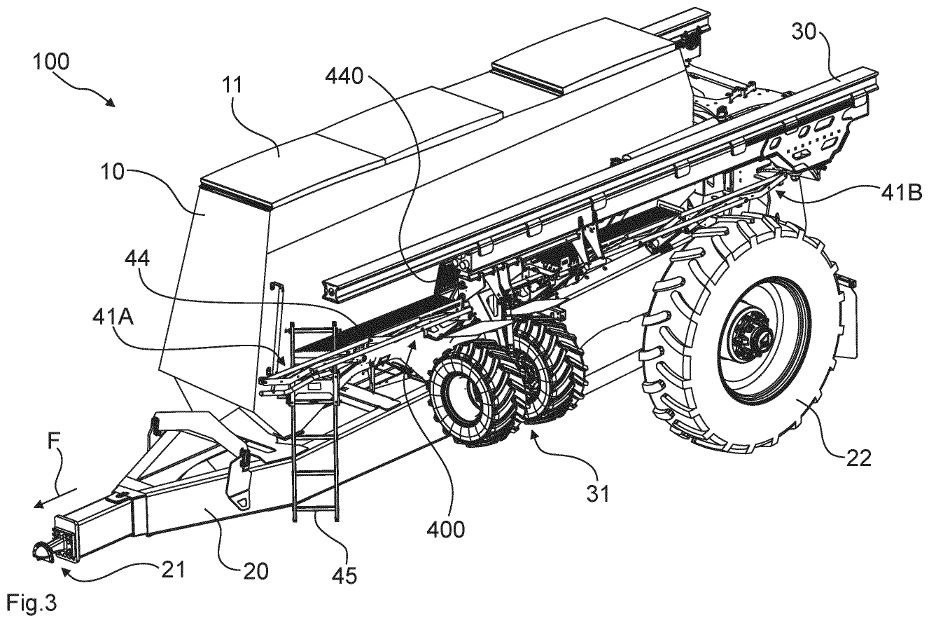

When the railing 40 is folded down and/or the tread 40 is raised, the sowing rail 30 or the cross member with the working tools 31 for the transport position, as shown in FIG. 3, can be placed at the side of the storage container 10 and/or above the platform 400. At least one of the working tools 31 may, as also shown, be able to be brought at least partially into an additional free space created by the raised segment 440 of the tread 44.

Furthermore, it should be mentioned that the platform 400 is arranged on the storage container 10 via several pivot points 46, designed here in the manner of angle elements. However, the pivot points 46 may alternatively or additionally also be connected to the frame 20 instead of to the storage container 10. For the sake of clarity, only the two outer pivot points 46, in particular the angle elements, are provided with reference signs in the figures. However, the platform 400 shown has further pivot points 46, in particular arranged at least approximately in the center of the platform 400, wherein it is again explicitly pointed out here that the platform 400, in particular depending on the requirements or length of the platform 400, may comprise only one or more of such pivot points 46. The pivot points 46 are assigned adjustment means, not shown in detail, which are designed to align the sections 41A, 41B with each another and/or to each other. In particular, the adjustment means are designed to adjust an inclination of the railing 40, preferably of the sections 41A, 41B, relative to the storage container 10 and/or transverse to the longitudinal axis L of the platform 400. In other words, the inclination of the one or more sections 41A, 41B is adjustable towards the storage container 10 or away from the storage container 10 as required, for example in the event of distortion of the railing 40, by means of the adjustment means. In this way, the alignment between the sections 41A, 41B is adjustable by means of the adjustment means. Such adjustment means may alternatively or additionally be arranged at only one or at several, in particular at each, of the pivot points 46.

It is understood that the features mentioned in the embodiments described above are not limited to these particular combinations and are also possible in any other combinations. Furthermore, it is understood that the geometries shown in the figures are only exemplary and are also possible in any other embodiments.

### LIST OF REFERENCE SIGNS

10 Storage container
100 Agricultural working machine
11 Container lid
20 Frame
21 Drawbar
22 Impeller
30 Sowing rail
31 Working tool
40 Railing
400 Platform
41A, 41B Sections of the railing
42A, 42B Rod and/or tube elements
43A, 43B Post elements
44 Tread
440 Segment of the tread
441 Axis
45 Step
45A, 45B Pivot axes
450A, 450B Pivot directions
46 Pivot point
50 Actuator
51 Sensor device
52 Actuating element
F Direction of travel
L Longitudinal axis

1. An agricultural working machine, in particular distribution machine, with a platform provided for walking on the working machine and having at least one step and/or a tread, which platform is arranged on the working machine so as to be able to be brought into different positions and comprises at least one railing, in particular designed in the manner of a guardrail, wherein the railing is divided at least in sections into a plurality of sections aligned at least approximately in parallel, which are pivotable; in a mutually repellent and/or opposing direction for lowering the railing.

2. The machine according to claim 1, wherein the sections are each pivotable about separate pivot axes assigned to the respective sections, wherein the pivot axes are aligned at least approximately perpendicularly and/or transversely to a longitudinal axis of the railing.

3. The working machine according to a claim 1, wherein the sections are each able to be brought separately from one another in a folded and/or folded-in manner when the railing is lowered.

4. The working machine according to claim 1, wherein the sections are pivotable with respect to each other for raising the railing.

5. The working machine according to claim 1, wherein the platform has at least one tread which is adjustable at least in sections into a raised position when the railing is lowered and/or during lowering of the railing.

6. The working machine according to claim 5, wherein the tread is divided into a plurality of segments, wherein at least one of the segments is adjustable into the raised position.

7. The working machine according to claim 6, wherein the sections are placeable at a defined distance from each other when the railing is lowered, wherein the distance corresponds at least approximately to the length of the at least one raisable segment of the tread.

8. The working machine according to claim 5, wherein at least one actuating element is provided between the railing and the tread between at least one section and at least one segment, which is designed to transmit an actuating force between the railing and the tread between the at least one section and the at least one segment to raise the tread.

9. The working machine according to claim 1, wherein the platform is assigned at least one actuator, which is designed to adjust the sections, and in particular the tread or the at least one segment, together in an alternating and/or successive manner.

10. The working machine according to et les claim 1, wherein the platform is assigned at least one sensor device, which is arranged on the actuator, and which is designed to detect at least one position of the platform, in particular of the sections.

11. The working machine according to claim 9, wherein the positions of the platform, in particular of the sections and/or of the tread, are adjustable in a remotely actuated and/or selected manner by an operator.

12. The working machine according to claim 9, wherein the positions of the platform, in particular of the sections and/or of the tread, are adjustable automatically, in particular by means of a control and/or feedback control system assigned to the working machine, particularly in such a way that the platform of the sections and/or the tread, is automatically folded in and/or out by means of the actuator and/or the control and/or feedback control system.

13. The working machine according to claim 12, wherein the positions of the platform, in particular of the sections and/or of the tread, are automatically adjustable depending on a position and/or change in position detectable by sensors, of the working machine by working tools: 44 assigned to the working machine, frames and/or at least one foldable cross member.

14. The working machine according to claim 1 wherein the platform is arranged via a plurality of pivot points on a frame of the working machine and/or on at least one storage container assigned to the working machine, wherein adjustment means are assigned to at least one of the pivot points, which adjustment means are designed to align the sections with each other.

15. The working machine according to claim 1, herein the working machine is designed in the manner of a towed agricultural seed drill.

16. The working machine according to claim 2, wherein the pivot axes are aligned at least approximately perpendicularly and/or transversely to a longitudinal axis of the sections.

17. The working machine according to claim 8, wherein the actuating force is transmitted between the railing and the tread to raise the at least one segment; during lowering of the railing.
